(19) United States
(12) Patent Application Publication
(10) Pub. No.: US 2025/0021427 A1
(43) Pub. Date: Jan. 16, 2025

(54) STORAGE CONTROLLER FOR RECOVERING DATA USING BIT COMBINATIONS AND METHOD OF OPERATING THE SAME

(71) Applicant: SK hynix Inc., Gyeonggi-do (KR)

(72) Inventors: Han CHOI, Gyeonggi-do (KR); Sang Won LEE, Gyeonggi-do (KR); Wook Sam JUNG, Gyeonggi-do (KR); Ki Sang CHO, Gyeonggi-do (KR)

(21) Appl. No.: 18/521,367

(22) Filed: Nov. 28, 2023

(30) Foreign Application Priority Data
Jul. 13, 2023 (KR) 10-2023-0091063

(51) Int. Cl. G06F 11/10

(52) U.S. Cl. CPC G06F 11/10; G06F 11/1032

(57) ABSTRACT

Provided herein may be a storage controller. The storage controller may generate a plurality of parity values by matching each of a plurality of first bit combinations corresponding to a number of error bits included in a target data set into positions of the error bits when the number of the error bits is less than a first reference value, and may determine a corrected bit combinations among the plurality of first bit combinations by comparing each of the plurality of parity values with a pre-generated parity value corresponding to the target data set.

### CROSS-REFERENCE TO RELATED APPLICATION

The present application claims priority under 35 U.S.C. § 119(a) to Korean patent application number 10-2023-0091063 filed on Jul. 13, 2023, the entire disclosure of which is incorporated by reference herein.

### BACKGROUND

### 1. Field of Invention

Various embodiments of the present disclosure relate to a storage controller and method of operating the storage controller.

### 2. Description of Related Art

A storage device is a device for storing data under the control of a host device such as a computer or a smartphone. The storage device may include a memory device for storing data and a storage controller for controlling the memory device. The memory device may be a volatile memory device or a non-volatile memory device.

The storage controller may detect an error in data and recover the data having the error by correcting the detected error.

### SUMMARY

Various embodiments of the present disclosure are directed to a storage controller capable of recovering data by using bit combinations corresponding to a number of error bits.

An embodiment of the present disclosure may provide for a storage controller. The storage controller may generate a plurality of parity values by matching each of a plurality of first bit combinations corresponding to a number of error bits included in a target data set into positions of the error bits when the number of the error bits is less than a first reference value, and determine a corrected bit combination among the plurality of first bit combinations by comparing each of the plurality of parity values with a pre-generated parity value corresponding to the target data set.

An embodiment of the present disclosure may provide for a method of operating a storage controller that stores a target data set. The method may include comparing a number of error bits included in the target data set with a first reference value, generating a plurality of parity values by matching each of a plurality of first bit combinations corresponding to a number of error bits into positions of the error bits according to a determination that the number of the error bits is less than the first reference value, and determining a corrected bit combination among the plurality of first bit combinations by comparing each of the plurality of parity values with a pre-generated parity value corresponding to the target data set.

### BRIEF DESCRIPTION OF THE DRAWINGS

Embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will convey the scope of the embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram illustrating a storage system according to an embodiment of the present disclosure.

FIG. 2 is a block diagram illustrating a storage controller shown in FIG. 1 in detail according to an embodiment of the present disclosure.

FIG. 3 is a diagram for describing a data recovery operation according to an embodiment of the present disclosure.

FIG. 4 is a diagram for describing first bit combinations according to an embodiment of the present disclosure.

FIG. 5 is a diagram for describing a parity table according to an embodiment of the present disclosure.

FIG. 6 is a diagram for describing a data recovery operation according to an embodiment of the present disclosure.

FIG. 7 is a diagram for describing second bit combinations according to an embodiment of the present disclosure.

FIG. 8 is a flowchart illustrating a method of operating a storage controller according to an embodiment of the present disclosure.

### DETAILED DESCRIPTION

Specific structural or functional descriptions in the embodiments of the present disclosure introduced in this specification are only for description of the embodiments of the present disclosure. The descriptions should not be construed as being limited to the embodiments described in the specification.

Additionally, terms such as “unit” and “module” or the functional blocks depicted in the accompanying drawings may be implemented in the form of software configuration, hardware configuration, or a combination thereof. In order to clearly describe the technical spirit of the present disclosure, detailed descriptions of overlapping elements will be omitted.

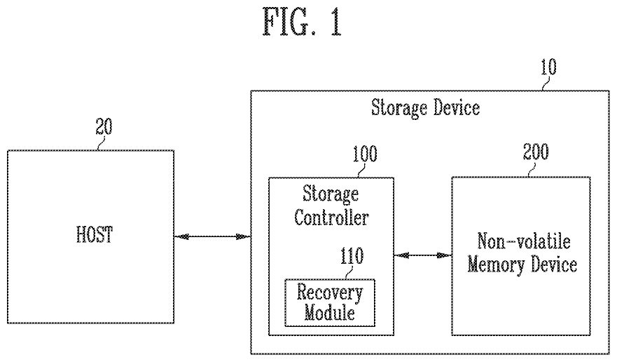

FIG. 1 is a block diagram illustrating a storage system according to an embodiment of the present disclosure.

Referring to FIG. 1, the storage system may include a storage device and a host 20 (i.e., an external device). In some embodiments, the storage system may be a computing system configured to process various pieces of information, such as a personal computer (PC), a notebook, a laptop, a server, a workstation, a tablet PC, a smart phone, a digital camera, a black box, and the like.

The host 20 may control general operations of the storage system. For example, the host 20 may store data in the storage device 10 or read out data stored in the storage device 10.

The storage device 10 may include a storage controller 100 and a non-volatile memory device 200. The non-volatile memory device 200 may store data. The storage controller 100 may store data in the non-volatile memory device 200 or read out data stored in the non-volatile memory device 200 according to a request from the host 20.

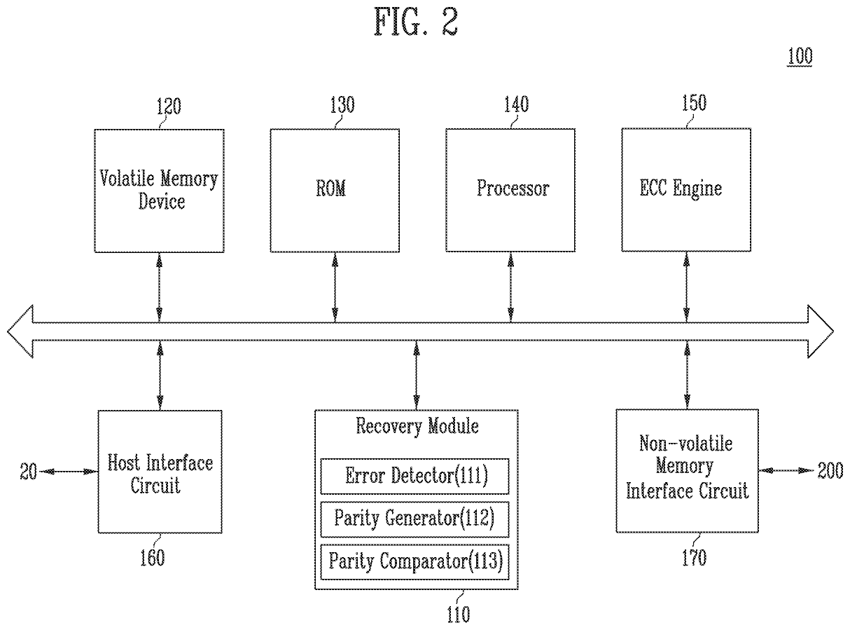

The storage controller 100 may include a recovery module 110. The recovery module 110 may perform a recovery operation on a data set stored in the memory device 200. The recovery operation may include generating bit combinations corresponding to a number of error bits occurring in a plurality of data areas, generating a plurality of parity values based on the generated bit combinations, and correcting the errors by comparing the plurality of parity values with a pre-generated parity value. The data set may include a plurality of data areas and a parity area. Each of the plurality of data areas may store data. The parity area may store a parity value for detection and correction of errors in the plurality of data areas. The parity value may be generated based on the data stored in the plurality of data areas. The recovery operation will be described in detail later in connection with FIGS. 2, 3 and 6.

In some embodiments, the non-volatile memory device 200 may be a NAND flash memory, but the scope of the present disclosure is not limited thereto. For example, the non-volatile memory device 200 may be one of various storage devices that may retain the stored data even when powered off, such as a phase-change random access memory (PRAM), a magnetic random-access memory (MRAM), a resistive random-access memory (RRAM), a ferroelectric random-access memory (FRAM), and the like.

FIG. 2 is a block diagram illustrating the storage controller 100 shown in FIG. 1 in detail according to an embodiment of the present disclosure.

Referring to FIGS. 1 and 2, the storage controller 100 may communicate with the host 20 and the non-volatile memory device 200. The storage controller 100 may include the recovery module 110, a volatile memory device 120, a read-only memory (ROM) 130, a processor 140, an error correction code (ECC) engine 150, a host interface circuit 160, and a non-volatile memory interface circuit 170.

The recovery module 110 may perform a recovery operation on a target data set. The target data set may be a data set to be used by the storage controller 100 among a plurality data sets. Specifically, the recovery module 110 may detect and correct errors in the target data set before the storage controller 100 uses the target data set.

The recovery module 110 may include an error detector 111, a parity generator 112, and a parity comparator 113. In some embodiments, the recovery module 110 may be implemented as software or firmware. For example, the non-volatile memory device 200 may store instructions corresponding to the recovery module 110. The processor 140 may load the instructions stored in the non-volatile memory device 200 onto the volatile memory device 120. The processor 140 may operate the recovery module 110 by executing the loaded instructions.

The error detector 111 may detect errors in the target data set and generate error bit information. The error bit information may include the number and positions of detected error bits. The positions of the error bits may indicate whether the error bits are included in the data areas of the target data set or included in the parity area of the target data set. The number of error bits may refer to the number of error bits included in the target data set.

The error detector 111 may stop (or suspend) the recovery operation when the error bits are included in the parity area. Specifically, the error detector 111 may not send the error bit information to the parity generator 112 when the error bits are included in the parity area. In some embodiments, when the error bits are included in the parity area, the recovery module 110 may stop determining a corrected bit combination. In some embodiments, the storage controller 100 may regenerate a pre-generated parity value when the error bits are included in the parity area. The storage controller 100 may generate a new parity value based on the bits in the data areas.

The error detector 111 may compare the number of error bits with a first reference value when the error bits are included in the data areas. When the number of the error bits is less than the first reference value, the error detector 111 may send the error bit information to the parity generator 112. The first reference value may be a criterion for identifying the number of error bits on which the recovery operation may be performed without requiring too much time.

When the number of error bits is equal to or greater than the first reference value, the error detector 111 may generate a maximum effective value. The maximum effective value may be the number of combinations of the effective values in the data areas in which the error bits are included. The error detector 111 may compare the maximum effective value with a second reference value. The second reference value may be a criterion for identifying data areas for which the recovery operation may be performed without requiring too much time.

The storage controller 100 may manage effective value information of each data area. In some embodiments, one of the volatile memory device 120 and the ROM 130 may store the effective value information of each data area.

When the maximum effective value is less than the second reference value, the error detector 111 may send the error bit information to the parity generator 112. When the maximum effective value is equal to or greater than the second reference value, the error detector 111 may stop the recovery operation. In some embodiments, when the maximum effective value is equal to or greater than the second reference value, the recovery module 110 may stop determining a corrected bit combination.

The parity generator 112 may generate a parity table based on the error bit information. The parity table may include a plurality of bit combinations and a plurality of parity values. The plurality of bit combinations may be one of a plurality of first bit combinations and a plurality of second bit combinations depending on the number of error bits. In some embodiments, when the number of error bits is less than the first reference value, the parity generator 112 may generate the parity table including the plurality of first bit combinations corresponding to the number of error bits. For example, when there are N error bits and N is less than the first reference value, the parity generator 112 may generate 2^{N} bit combinations, where N is a natural number.

In some embodiments, when the number of error bits is equal to or greater than the first reference value, the parity generator 112 may generate the plurality of first bit combinations corresponding to the number of error bits for each data area, and generate a parity table including the plurality of second bit combinations corresponding to a combination of the plurality of first bit combinations.

Each of the plurality of parity values may be generated by matching each bit combination to positions of the error bits. The parity generator 112 may generate the plurality of parity values by matching each bit combination to positions of the error bits. For example, 2^{N} parity values may be generated by matching each of the 2^{N} bit combinations to positions of the error bits.

The parity comparator 113 may determine, based on the parity table, a parity value equal to the pre-generated parity value among the plurality of parity values. The pre-generated parity value may be a parity value stored in the parity area of the target data set. When a first parity value of the plurality of parity values is equal to the pre-generated parity value, the parity comparator 113 may determine, as a corrected bit combination, a bit combination corresponding to the first parity value. The parity comparator 113 may generate a corrected data set by matching the corrected bit combination to positions of the error bits. The corrected data set may refer to a data set obtained by correcting the error bits included in the target data set. The parity comparator 113 may stop the recovery operation when two or more of the plurality of parity values are equal to the pre-generated parity value. In some embodiments, when two or more of the plurality of parity values are equal to the pre-generated parity value, the recovery module 110 may stop determining the corrected bit combination.

The volatile memory device 120 may serve as a main memory, cache memory, or operation memory of the storage controller 100. For example, the volatile memory device 120 may be implemented based on at least one of various volatile memories such as a static random-access memory (SRAM), a dynamic random-access memory (DRAM), and the like. The ROM 130 may be used for a read-only memory to store information required for operation of the storage controller 100. In some embodiments, the volatile memory device 120 and the ROM 130 may include a plurality of data sets. The recovery module 110 may perform the recovery operation on the plurality of data sets stored in the volatile memory device 120 and the ROM 130. The present disclosure is not, however, limited thereto, and the recovery module 110 may perform the recovery operation for a device that may store data, such as a register.

The processor 140 may control general operations of the storage controller 100. An ECC engine 150 may detect and correct an error in data read from the non-volatile memory device 200. For example, the ECC engine 150 may have a certain level of error correction capability. The ECC engine 150 may handle data having an error level (e.g., the number of flipped bits) that exceeds the error correction capability as uncorrectable data.

In some embodiments, the recovery module 110 may perform the recovery operation on the data processed by the ECC engine 150. For example, the recovery module 110 may perform the recovery operation on the data stored in the volatile memory device 120 or the ROM 130 by the ECC engine 150 correcting the error in the data read from the non-volatile memory device 200. In some embodiments, the recovery module 110 may perform the recovery operation separately from the ECC engine 150.

The storage controller 100 may communicate with the host 20 through the host interface circuit 160. In some embodiments, the host interface circuit 160 may be implemented based on at least one of various communication standards or interfaces such as serial AT attachment (SATA), peripheral component interconnect express (PCIe), a serial attached SCSI (SAS) interface, an embedded multimedia card (eMMC) interface, a universal flash storage (UFS), and the like.

The storage controller 100 may communicate with the non-volatile memory device 200 through the non-volatile memory interface circuit 170. In some embodiments, the non-volatile memory interface circuit 170 may be implemented based on a NAND flash interface, such as open NAND flash interface (ONFI) and Toggle standards.

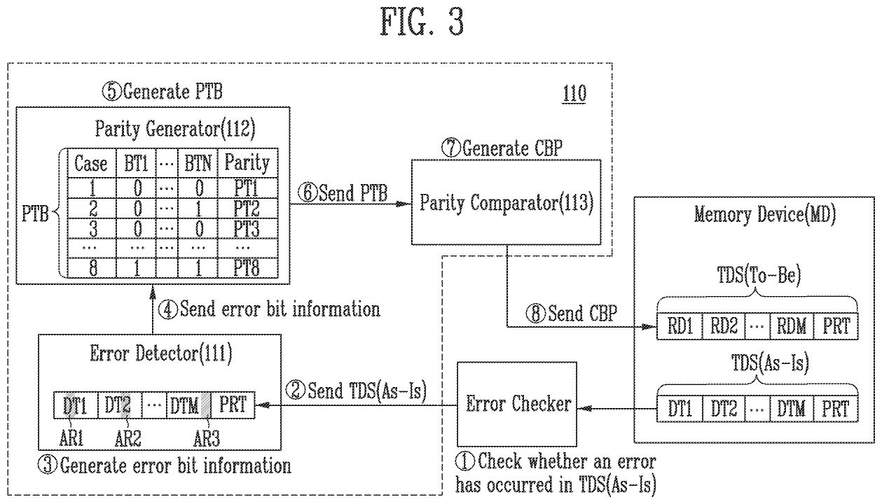

FIG. 3 is a diagram for describing a data recovery operation according to an embodiment of the present disclosure.

Referring to FIG. 3, shown is a recovery operation in which the recovery module 110 corrects an error in a target data set stored in the memory device MD included in the storage controller 100. The recovery module 110 may include the error detector 111, the parity generator 112, and the parity comparator 113, which may correspond to the error detector 111, the parity generator 112 and the parity comparator 113 shown in FIG. 2, respectively.

A method of operating the recovery module 110 for performing a recovery operation on a target data set will now be described according to some embodiments of the present disclosure. A target data set before being subjected to correction of errors in data areas by the recovery module 110 is denoted “As-Is”, and a target data set after being subjected to correction of the errors in the data areas is denoted as “To-Be”. This may be a case that the number of error bits is less than the first reference value.

The memory device MD may be one of the volatile memory device 120 and the ROM 130 shown in FIG. 2. The present disclosure is not, however, limited thereto, and the memory device MD may include a device that may store data such as a register.

In first operation \textcircled{1}, an error checker included in the storage controller 100 may determine (or check) whether there is an error in a target data set (TDS) As-Is. In one embodiment, the error checker may be implemented as a component included in the ECC engine 150 of FIG. 2 or as a component not shown in FIG. 2 but included in the storage controller 100. The error checker may determine whether there is an error by applying an integrity algorithm to the target data set As-Is. In some embodiments, the integrity algorithm may include checksum, cyclic redundancy check (CRC), a secure hash algorithm (SHA), and a hash-based message authentication code (HMAC). The target data set As-Is may include a plurality of data areas DT1 to DTM and a parity area PRT, where M is a natural number greater than 1.

In second operation \textcircled{2}, the error checker may transmit the target data set As-Is to the error detector 111 when the target data set As-Is includes an error. When there is no error included in the target data set As-Is, the recovery operation may be stopped.

In third operation \textcircled{3}, the error detector 111 may generate error bit information by detecting error bits in the target data set As-Is. The error detector 111 may detect error bits of first area AR1 in the first data area DT1, second area AR2 in the second data area DT2, and third area AR3 in the M-th data area DTM. The first area AR1, the second area AR2, and the third area AR3 may each be an area including one error bit. The present disclosure is not, however, limited thereto, and the first area AR1, the second area AR2, and the third area AR3 may each include one or more error bits.

For example, referring to FIG. 3, the error detector 111 may generate error bit information including positions of the error bits (e.g., the first area AR1, the second area AR2 and the third area AR3) and the number of the error bits (e.g., 3).

In fourth operation \textcircled{4}, the error detector 111 may send the error bit information to the parity generator 112 when the error bits are included in the data areas of the target data set and the number of error bits is less than the first reference value.

For example, when the first reference value is 16, positions of the error bits (e.g., the first area AR1, the second area AR2 and the third area AR3) are included in the plurality of data areas DT1 to DTM, and the number of error bits is 3, the error detector 111 may send the error bit information to the parity generator 112 based on the error bits included in the plurality of data areas and the number of error bits being less than the first reference value.

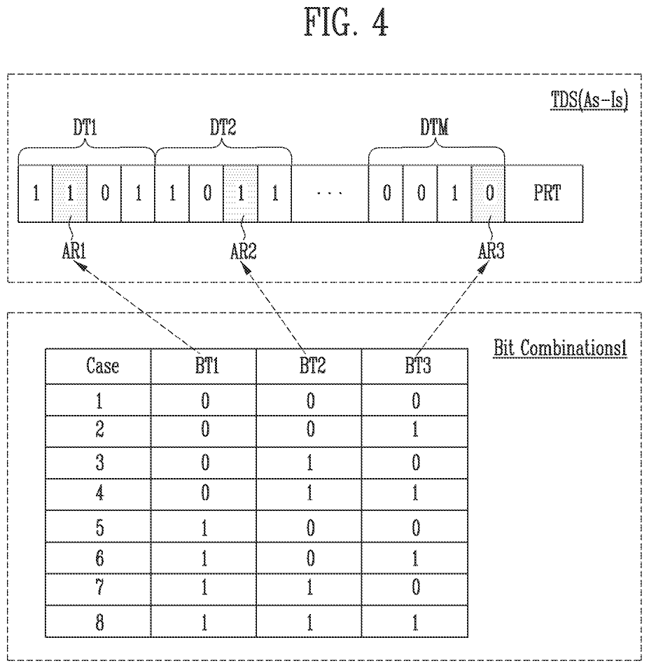

In fifth operation \textcircled{5}, the parity generator 112 may generate a parity table PTB based on the error bit information. Based on the number of error bits less than the first reference value, the parity generator 112 may generate the parity table including the plurality of first bit combinations and a plurality of parity values. For example, based on the number of error bits being 3, the parity generator 112 may generate first to eighth bit combinations. Each of the first to eighth bit combinations may include first to N-th bits (BT1 to BTN). Furthermore, the parity generator 112 may generate the first to eighth parity values PT1 to PT8 by matching each of the first to eighth bit combinations to positions of the error bits. This will be described in more detail later in connection with FIG. 4.

In sixth operation \textcircled{6}, the parity generator 112 may send the parity table PTB to the parity comparator 113.

In seventh operation \textcircled{7}, the parity comparator 113 may compare each of the first to eighth parity values PT1 to PT8 with a pre-generated parity value to generate a corrected bit combination (CBP). The parity comparator 113 may determine a bit combination, corresponding to a parity value equal to the pre-generated parity value among the first to eighth parity values PT1 to PT8, to be the corrected bit combination. For example, when the first parity value PT1 of the first to eighth parity values PT1 to PT8 is equal to the pre-generated parity value, the first bit combination may be determined to be the corrected bit combination.

The parity comparator 113 may stop the recovery operation when there is no parity value equal to the pre-generated parity value or there are two or more parity values equal to the pre-generated parity value among the plurality of parity values. The parity comparator 113 may stop the operation of determining a corrected bit combination.

In eighth operation \textcircled{8}, the parity comparator 113 may send, to the memory device MD, a target data set (TDS) To-Be generated by matching the corrected bit combination (CBP) to positions of the error bits. The target data set To-Be may be a data set in which the corrected bit combination is placed onto the first to third areas AR1 to AR3.

For example, the first area AR1 of a first recovery data area RD1 may include the first bit BT1 in the corrected bit combination. The second area AR2 of a second recovery data area RD2 may include the second bit BT2 in the corrected bit combination. The third area AR3 of an M-th recovery data area RDM may include the third bit in the corrected bit combination. That is, the target data set To-Be may be a data set obtained by correcting the error bits detected from the target data set As-Is based on the corrected bit combination.

By recovering original data using the parity values generated by matching all bit combinations that may be generated with a number of error bits and the pre-generated parity value, memory use space may be reduced, data correction capability may be improved, and reliability of the storage device including the storage controller may be enhanced.

FIG. 4 is a diagram for describing first bit combinations according to an embodiment of the present disclosure.

Referring to FIGS. 3 and 4, shown is a target data set As-Is including first to M-th data areas DT1 to DTM and a parity area PRT. The target data set As-Is shown in FIG. 4 may correspond to the target data set As-Is shown in FIG. 3. Each of the first to M-th data areas DT1 to DTM may include 4 bits. The diagram illustrating that each of the first to M-th data areas DT1 to DTM includes 4 bits in FIG. 4 is merely for convenience of description, but the present disclosure is not limited thereto and the first to M-th data areas DT1 to DTM may each include 4 or more bits depending on settings of the user of the storage controller.

The parity generator 112 may generate a plurality of bit combinations based on the error bit information. Bits included in each bit combination may correspond to the first to third areas AR1 to AR3, respectively. For example, the first bit BT1 of each bit combination may correspond to the first area AR1. The second bit BT2 of each bit combination may correspond to the second area AR2. The third bit BT3 of each bit combination may correspond to the third area AR3.

The parity generator 112 may generate the plurality of first bit combinations based on the number of error bits being less than a first value. For example, when the number of error bits is 3, the parity generator 112 may generate the plurality of first bit combinations corresponding to 3 bits. The plurality of first bit combinations may include first to eighth bit combinations. For example, the first bit combination may be “000” (i.e., the first bit BT1 is ‘0’, the second bit BT2 is ‘0’ and the third bit BT3 is ‘0’). The second bit combination may be “001” (i.e., the first bit BT1 is ‘0’, the second bit BT2 is ‘0’ and the third bit BT3 is ‘1’). The third bit combination may be “010” (i.e., the first bit BT1 is ‘0’, the second bit BT2 is ‘1’ and the third bit BT3 is ‘0’). The fourth bit combination may be “011” (i.e., the first bit BT1 is ‘0’, the second bit BT2 is ‘1’ and the third bit BT3 is ‘1’). The fifth bit combination may be “100” (i.e., the first bit BT1 is ‘1’, the second bit BT2 is ‘0’ and the third bit BT3 is ‘0’). The sixth bit combination may be “101” (i.e., the first bit BT1 is ‘1’, the second bit BT2 is ‘0’ and the third bit BT3 is ‘1’). The seventh bit combination may be “110” (i.e., the first bit BT1 is ‘1’, the second bit BT2 is ‘1’ and the third bit BT3 is ‘0’). The eighth bit combination may be “111” (i.e., the first bit BT1 is ‘1’, the second bit BT2 is ‘1’ and the third bit BT3 is ‘1’).

The parity generator 112 may generate the first to eighth parity values by matching each of the first to eighth bit combinations to the positions AR1, AR2 and AR3 of the error bits. In some embodiments, the parity generator 112 may match the first to third bits BT1 to BT3 of a bit combination to the first to third areas AR1 to AR3, respectively.

For example, to generate the first parity value, the parity generator 112 may form the data areas by matching the first bit ‘0’ of the first bit combination to the first area AR1, matching the second bit ‘0’ of the first bit combination to the second area AR2 and matching the third bit ‘0’ of the first bit combination to the third area AR3. The parity generator 112 may generate the first parity value based on the data areas with the first bit combination matched to the first to third areas AR1 to AR3.

To generate the third parity value, the parity generator 112 may form the data areas by matching the first bit ‘0’ of the third bit combination to the first area AR1, matching the second bit ‘1’ of the third bit combination to the second area AR2 and matching the third bit ‘0’ of the third bit combination to the third area AR3. The parity generator 112 may generate the third parity value based on the data areas with the third bit combination placed into the first to third areas AR1 to AR3.

The parity generator 112 may generate the second, fourth to eighth parity values in a similar way of generating the first and third parity values.

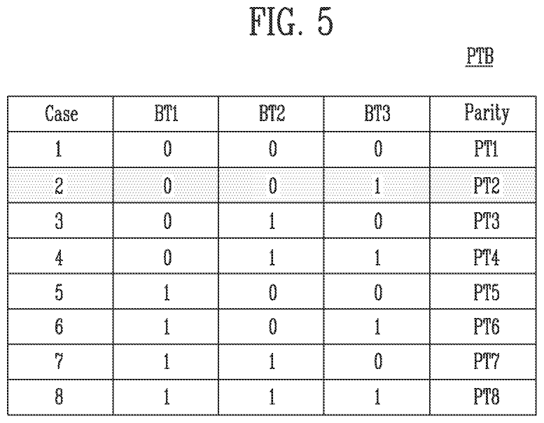

FIG. 5 is a diagram for describing a parity table according to an embodiment of the present disclosure.

Referring to FIGS. 3 to 5, shown is a parity table PTB in a case that the error bits are positioned in the first area AR1, the second area AR2 and the third area AR3 and the number of error bits is 3. The parity table PTB shown in FIG. 5 may correspond to the parity table PTB shown in FIG. 3.

The parity table PTB may include the plurality of first bit combinations and a plurality of parity values. For example, the parity table PTB may include first to eighth bit combinations and first to eighth parity values PT1 to PT8. The first to eighth bit combinations may correspond to the first to eighth parity values PT1 to PT8, respectively.

The parity comparator 113 may compare each of the first to eighth parity values PT1 to PT8 with a pre-generated parity value to generate a corrected bit combination. For example, when the second parity value PT2 of the first to eighth parity values PT1 to PT8 is equal to the pre-generated parity value, the parity comparator 113 may determine, as a corrected bit combination, the second bit combination corresponding to the second parity value PT2.

The parity comparator 113 may correct the detected errors by matching the corrected bit combination to the positions of the error bits. For example, referring to FIG. 4, the parity comparator 113 may generate a corrected data set by matching the first bit ‘0’ of the second bit combination to the first area AR1, matching the second bit ‘0’ of the second bit combination to the second area AR2 and matching the third bit ‘1’ of the second bit combination to the third area AR3.

In some embodiments, the parity comparator 113 may stop the recovery operation when two or more of the first to eighth parity values PT1 to PT8 are equal to the pre-generated parity value. For example, when the second and eighth parity values PT2 and PT8 among the first to eighth parity values PT1 to PT8 are equal to the pre-generated parity value, the parity comparator 113 may stop the recovery operation.

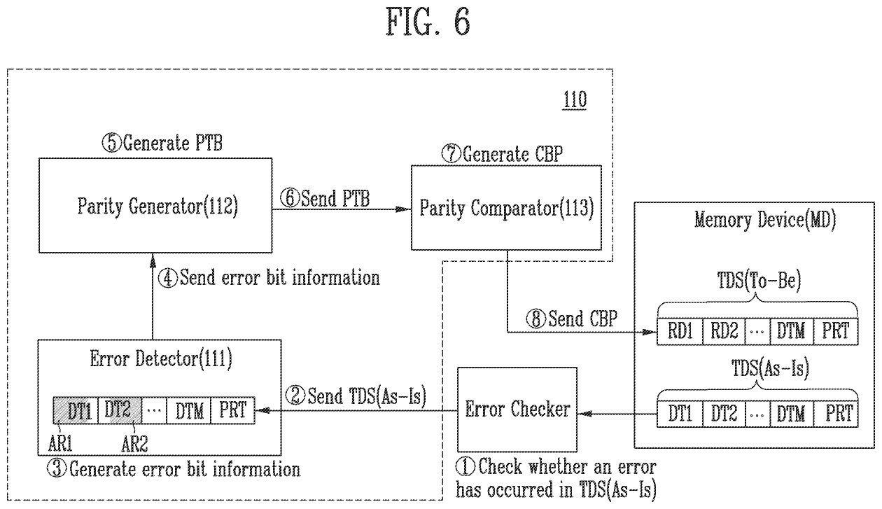

FIG. 6 is a diagram for describing a data recovery operation according to an embodiment of the present disclosure.

The recovery module 110 may include the error detector 111, the parity generator 112, and the parity comparator 113. The error detector 111, the parity generator 112 and the parity comparator 113 may correspond to the error detector 111, the parity generator 112 and the parity comparator 113 shown in FIG. 2, respectively.

A method of operating the recovery module 110 for performing a recovery operation on a target data set will now be described according to some embodiments of the present disclosure. A target data set before being subjected to correction of errors in data areas by the recovery module 110 is denoted “As-Is”, and a target data set after being subjected to correction of the errors in the data areas is denoted as “To-Be”. This may be a case that the number of error bits is equal to or greater than the first reference value.

In first operation \textcircled{1}, an error checker may determine whether there is an error in a target data set (TDS) As-Is. The error checker may determine whether there is an error by applying an integrity algorithm to the target data set As-Is. The target data set As-Is may include a plurality of data areas DT1 to DTM and a parity area PRT.

In second operation \textcircled{2}, the error checker may transmit the target data set As-Is to the error detector 111 when the target data set As-Is includes an error. When there is no error included in the target data set As-Is, the recovery operation may be stopped.

In third operation \textcircled{3}, the error detector 111 may generate error bit information by detecting error bits in the target data set As-Is. For example, referring to FIG. 6, the error detector 111 may detect error bits of the first area AR1 in the first data area DT1 and error bits of the second area AR2 in the second data area DT2. The error detector 111 may generate error bit information including positions of the error bits (e.g., the first area AR1 and the second area AR2) and the number of error bits (e.g., 20).

In fourth operation \textcircled{4}, the error detector 111 may send the error bit information to the parity generator 112 when the number of error bits is equal to or greater than the first reference value and a maximum effective value is less than the second reference value.

When the number of error bits is equal to or greater than the first reference value, the error detector 111 may generate a maximum effective value. The maximum effective value may be a combination of the number of effective values of the data area in which each of the error bits is included. When error bits occur in the first area AR1 in the first data area DT1 and the second area AR2 in the second data area DT2, the maximum effective value may be the number of combinations of effective values of the first data area DT1 and effective values of the second data area DT2.

For example, when the effective values of the first data area DT1 are ‘0’, ‘1’ and ‘2’ and the effective values of the second data area DT2 are ‘0’, ‘1’ and ‘2’, the error detector 111 may generate a maximum effective value having ‘9’ by calculating a combination of the effective values of the first data area DT1 and the effective values of the second data area DT2 (e.g., 3×3=9).

The error detector 111 may compare the maximum effective value with the second reference value. When the maximum effective value is less than the second reference value, the error detector 111 may send the error bit information to the parity generator 112.

For example, referring to FIG. 6, as the number of error bits (e.g., 20) is greater than the first reference value (e.g., 16), the error detector 111 may compare the maximum effective value with the second reference value. When the number of the effective values of the first data area DT1 is 128 and the number of effective values of the second data area DT2 is 128, the error detector 111 may generate a maximum effective value having ‘16,384’ based on the combination of the effective values of the first data area DT1 and the effective values of the second data area DT2 being 16,384. The error detector 111 may send the error bit information to the parity generator 112 as the maximum effective value (e.g., 16,384) is less than the second reference value (e.g., 65,536).

In fifth operation \textcircled{5}, the parity generator 112 may generate the parity table PTB based on the error bit information. When the number of error bits is larger than the first reference value and the maximum effective value is less than the second reference value, the parity generator 112 may generate the plurality of second bit combinations corresponding to a combination of the plurality of first bit combinations corresponding to the number of error bits for each data area.

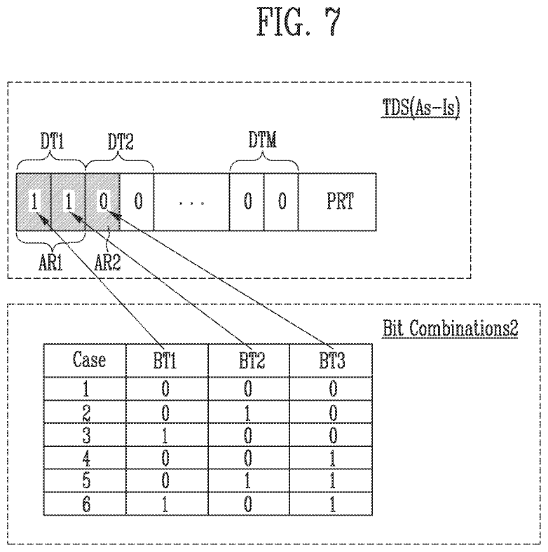

Referring to FIG. 6, the parity generator 112 may generate a plurality of first bit combinations corresponding to the number of error bits in the first data area DT1 and a plurality of first bit combinations corresponding to the number of error bits in the second data area DT2. The parity generator 112 may generate a plurality of parity values by matching each of the plurality of second bit combinations to positions of the error bits. This will be described in more detail later in connection with FIG. 7.

In operation \textcircled{6}, the parity generator 112 may send the parity table PTB to the parity comparator 113.

In seventh operation \textcircled{7}, the parity comparator 113 may compare each of the plurality of parity values with a pre-generated parity value to generate a corrected bit combination (CBP). The parity comparator 113 may determine, as a corrected bit combination, a bit combination corresponding to a parity value equal to the pre-generated parity value among the plurality of parity values.

In some embodiments, the parity comparator 113 may determine whether there is one parity value equal to the pre-generated parity value among the plurality of parity values. When there is one parity value equal to the pre-generated parity value among the plurality of parity values, the parity comparator 113 may determine, as a corrected bit combination, a bit combination corresponding to the parity value. The parity comparator 113 may stop the recovery operation when there is no parity value equal to the pre-generated parity value or there are two or more parity values equal to the pre-generated parity value among the plurality of parity values. The parity comparator 113 may stop the operation of determining a corrected bit combination.

In eighth operation \textcircled{8}, the parity comparator 113 may send, to the memory device MD, a target data set (TDS) To-Be generated by matching the corrected bit combination (CBP) to the positions of the error bits. The target data set To-Be may be a data set subjected to correction of the error bits detected from the target data set As-Is.

For example, a first recovery area RD1 and a second recovery area RD2 may include the corrected bit combination. The target data set To-Be may be a data set obtained by correcting the error bits detected from the target data set As-Is based on the corrected bit combination.

Even when as many error bits as the first reference value or more occur, memory use space may be reduced, data correction capability may be improved, and reliability of the storage device that stores the storage controller may be enhanced by recovering original data using the parity values generated by matching a combination of the bit combinations corresponding to the number of error bits and the pre-generated parity value, depending on the maximum effective value.

FIG. 7 is a diagram for describing second bit combinations according to an embodiment of the present disclosure.

Referring to FIGS. 6 and 7, shown is a target data set As-Is including first to M-th data areas DT1 to DTM and a parity area PRT. The target data set As-Is shown in FIG. 7 may correspond to the target data set As-Is shown in FIG. 6. Each of the first to M-th data areas DT1 to DTM may include two bits. The diagram illustrating that each of the first to M-th data areas DT1 to DTM includes two bits in FIG. 7 is merely for convenience of description, but the present disclosure is not limited thereto and the first to M-th data areas DT1 to DTM may each include 2 or more bits depending on settings of the user of the storage controller.

The parity generator 112 may generate a plurality of bit combinations based on the error bit information. The parity generator 112 may generate the plurality of second bit combinations based on the number of error bits larger than the first reference value. For example, when the first reference value is 2 and the number of error bits is 3, the parity generator 112 may generate the plurality of second bit combinations.

Referring to FIG. 7, there may be error bits in the first area AR1 of the first data area DT1 and the second area AR2 of the second data area DT2. The effective value of the first data area DT1 may be a natural number between “0” and “2”. The effective value of the second data area DT2 may be a natural number between “0” and “2”. The parity generator 112 may generate a plurality of first bit combinations (e.g., ‘00’, ‘01’, and ‘10’) corresponding to the number of error bits in the first data area DT1 that includes the first area AR1 and generate a plurality of first bit combinations (e.g., ‘0’ and ‘1’) corresponding to the number of error bits in the second data area DT2 including the second area AR2. The parity generator 112 may generate a plurality of second bit combinations (e.g., ‘000’, ‘010’, ‘100’, ‘001’, ‘011’, and ‘101’) by combining the plurality of first bit combinations of the first data area DT1 and the plurality of first bit combinations of the second data area DT2.

The parity generator 112 may generate the first to sixth parity values by matching each of the first to sixth bit combinations to the first area AR1 and the second area AR2.

For example, the parity generator 112 may generate a first parity value based on the first data area DT1 and the second data area DT2 to which the first bit combination “000” is matched and the existing third to M-th data areas DTM. The parity generator 112 may generate a third parity value based on the first data area DT1 and the second data area DT2 to which the third bit combination “100” is matched and the existing third to M-th data areas DTM.

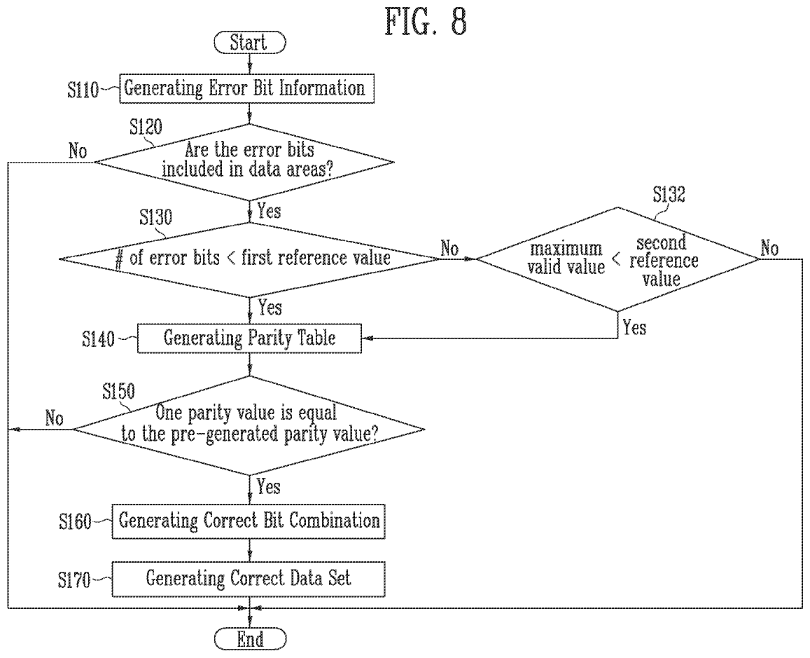

FIG. 8 is a flowchart illustrating a method of operating a storage controller according to an embodiment of the present disclosure.

Referring to FIG. 8, how the storage controller performs a recovery operation on a data set will be described. The storage controller may correspond to the storage controller 100 shown in FIG. 2. The storage controller may include the recovery module 110 as described above in connection with FIGS. 2, 3 and 6.

At operation S110, the storage controller may generate error bit information. The storage controller may generate the error bit information by detecting error bits in a data set. The error bit information may include positions of the error bits and the number of the error bits.

In some embodiments, the storage controller may apply an integrity algorithm to the data set before generating the error bit information. When an error occurs in the data set, the storage controller may detect error bits in the data set.

At operation S120, the storage controller may determine whether the error bits are included in data areas. When the error bits are included in the data areas (i.e., Yes in the operation S120), the storage controller may perform operation S130. When the error bits are not included in the data areas (i.e., No in the operation S120), the storage controller may stop (or suspend) the recovery operation. In some embodiments, the storage controller may regenerate a pre-generated parity value and stop the recovery operation, when the error bits are included in the parity area.

At the operation S130, the storage controller may compare the number of error bits with a first reference value. When the number of error bits is less than the first reference value (i.e., Yes in the operation S130), the storage controller may perform operation S140. When the number of the error bits is equal to or greater than the first reference value (i.e., No in the operation S130), the storage controller may perform operation S132.

At the operation S132, the storage controller may compare the maximum effective value with a second reference value. The storage controller may generate the maximum effective value based on the error bit information. The storage controller may generate the maximum effective value by combining maximum values of effective values of the data areas including error bits. When the maximum effective value is less than the second reference value (i.e., Yes in the operation S132), the storage controller may perform the operation S140. When the maximum effective value is equal to or greater than the second reference value (i.e., No in the operation S132), the storage controller may stop the recovery operation.

At the operation S140, the storage controller may generate a parity table. The parity table may include a plurality of bit combinations and a plurality of parity values. In some embodiments, when the number of error bits is less than the first reference value, the storage controller may generate a plurality of first bit combinations corresponding to the number of error bits. The storage controller may generate a plurality of parity values by matching each of the plurality of first bit combinations to positions of the error bits.

In some embodiments, when the number of error bits is equal to or greater than the first reference value, the storage controller may generate a plurality of second bit combinations. The storage controller may generate a plurality of parity values by matching each of the plurality of second bit combinations to the data area.

At operation S150, the storage controller may determine whether there is one parity value equal to the pre-generated parity value among the plurality of parity values. The storage controller may stop the recovery operation when there is more or less than one parity value equal to the pre-generated parity value (i.e., No in the operation S150). For example, the recovery operation may be stopped when there are two or more parity values equal to the pre-generated parity value or there is no parity value equal to the pre-generated parity value. The storage controller may perform operation S160 when there is one parity value equal to the pre-generated parity value (i.e., Yes in the operation S150). At the operation S160, the storage controller may generate a corrected bit combination. The storage controller may determine, as the corrected bit combination, a bit combination corresponding to a parity value equal to the pre-generated parity value among the plurality of parity values.

At operation S170, the storage controller may generate a corrected data set. The storage controller may generate the corrected data set by matching the corrected bit combination to the positions of the error bits.

Embodiments of the present disclosure provide a storage controller for recovering data by using bit combinations corresponding to a number of error bits. The technology may reduce memory use space, improve data correction capability, and enhance reliability of a storage device including the storage controller.

While the present disclosure has been shown and described with reference to certain embodiments thereof, it will be understood by those skilled in the art that various changes in form and details may be made therein without departing from the scope of the present disclosure and any equivalents. Therefore, the scope of the present disclosure should not be limited to the above-described embodiments but should include the equivalents thereof.

In the above-described embodiments, all operations may be selectively performed or part of the operations may be omitted. In each embodiment, the operations are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the embodiments of the present disclosure have been described in the drawings and specification. Although specific terminologies are used here, those are only to describe the embodiments of the present disclosure. Therefore, the present disclosure is not restricted to the above-described embodiments and many variations are possible within the scope of the present disclosure. It should be apparent to those skilled in the art that various modifications can be made on the basis of the technological scope of the present disclosure in addition to the embodiments disclosed herein. Furthermore, the embodiments may be combined to form additional embodiments.

What is claimed is:

1. A storage controller configured to:
generate a plurality of parity values by matching each of a plurality of first bit combinations corresponding to a number of error bits included in a target data set to positions of the error bits when the number of the error bits is less than a first reference value; and
determine a corrected bit combination among the plurality of first bit combinations by comparing each of the plurality of parity values with a pre-generated parity value corresponding to the target data set.

2. The storage controller according to claim 1, wherein the storage controller is configured to generate recovered data corresponding to the target data set by matching the corrected bit combination to the positions of the error bits.

3. The storage controller according to claim 1, wherein the storage controller is configured to determine, as the corrected bit combination, a bit combination corresponding to a first parity value of the plurality of parity values among the plurality of first bit combinations when the first parity value is equal to the pre-generated parity value.

4. The storage controller according to claim 1, wherein the storage controller is configured to stop determining the corrected bit combination when a first parity value and a second parity value of the plurality of parity values are equal to the pre-generated value.

5. The storage controller according to claim 1, wherein:
the target data set comprises a plurality of data areas and a parity area; and
the parity area is configured to store the pre-generated parity value.

6. The storage controller according to claim 5, wherein the pre-generated parity value is regenerated when the error bits are included in the parity area of the target data set.

7. The storage controller according to claim 1, wherein the storage controller is configured to:
generate a maximum effective value by calculating a number of combinations of effective values of each data area including the error bits among a plurality of data areas of the target data set when the number of error bits is equal to or greater than a first reference value;
compare the maximum effective value with a second reference value;
generate a plurality of second bit combinations based on a combination of bit combinations corresponding to a number of error bits of each of the data areas when the maximum effective value is less than the second reference value;
generate the plurality of parity values by matching each of the plurality of second bit combinations to positions of the error bits; and
determine the corrected bit combination among the plurality of second bit combinations by comparing each of the plurality of parity values with the pre-generated parity value.

8. The storage controller according to claim 7, wherein the storage controller is configured to stop determining the corrected bit combination when the maximum effective value is equal to or greater than the second reference value.

9. A method of operating a storage controller that stores a target data set, the method comprising:
comparing a number of error bits included in the target data set with a first reference value;
generating a plurality of parity values by matching each of a plurality of first bit combinations corresponding to the number of error bits to positions of the error bits according to a determination that the number of the error bits is less than the first reference value; and
determining a corrected bit combination among the plurality of first bit combinations by comparing each of the plurality of parity values with a pre-generated parity value corresponding to the target data set.

10. The method according to claim 9, further comprising generating recovered data corresponding to the target data set by matching the corrected bit combination to positions of the error bits.

11. The method according to claim 9, wherein determining the corrected bit combination comprises determining, as the corrected bit combination, a bit combination corresponding to a first parity value of the plurality of parity values according to a determination that the first parity value is equal to the pre-generated parity value.

12. The method according to claim 9, wherein determining the corrected bit combination comprises stopping determining the corrected bit combination according to a determination that a first parity value and a second parity value of the plurality of parity values are equal to the pre-generated parity value.

13. The method according to claim 9, further comprising:
generating a maximum effective value by calculating a number of combinations of effective values of each data area including the error bits among a plurality of data areas of the target data set, according to a determination that the number of error bits is equal to or greater than a first reference value;
comparing the maximum effective value with a second reference value;
generating a plurality of second bit combinations based on a combination of bit combinations corresponding to a number of error bits of each of the data areas according to a determination that the maximum effective value is less than the second reference value;
generating the plurality of parity values by matching each of the plurality of second bit combinations to positions of the error bits; and
determining the corrected bit combination among the plurality of second bit combinations by comparing each of the plurality of parity values with the pre-generated parity value.

14. The method according to claim 13, further comprising stopping determining the corrected bit combination according to a determination that the maximum effective value is equal to or greater than the second reference value.

15. The method according to claim 9, further comprising:
detecting the error bits from the target data set; and
comparing the number of error bits with the first reference value according to a determination that the error bits are included in data areas of the target data set.

16. The method according to claim 15, further comprising regenerating the pre-generated parity value according to a determination that the error bits are included in a parity area of the target data set.
